(19) United States
(12) Patent Application Publication
(10) Pub. No.: US 2007/0159626 A1
(43) Pub. Date: Jul. 12, 2007

(54) Method and Apparatus for High Resolution Spectroscopy

(76) Inventor: Oren Aharon, Haifa (IL)

Correspondence Address: YORAM TSIVION, P.O. BOX 1307, PARDES HANNA, 37111, omitted

(21) Appl. No.: 11/619,629

(22) Filed: Jan. 4, 2007

(30) Foreign Application Priority Data
Jan. 9, 2006 (IL) 173025

(51) Int. Cl. G01J 3/28

(52) U.S. Cl. 356/328; 356/326

(57) ABSTRACT

A method and a matching system for providing high resolution spectroscopy measurements. Input light beam is spread, forming two dimensional array of beams. These beams are further intercepted by two dimensional detecting means. A corresponding electronic system interprets the power collected by each detecting element subsequently producing spectral data.

### FIELD OF THE INVENTION

The present invention relates to the art of spectrometry, spectroscopic instruments. Specifically, the invention relates to a novel approach utilizing a two dimensional sensor and a specific optical system for arranging the distinct parts of the spectrum on the sensor in order to utilize the sensor area to its full resolution. The focus of the invention is in utilization of the above method for creating ultra-high resolution spectrometer instrument. The invention enables creation of a simple and reliable system for high resolution spectroscopy applications capable to display an input spectrum with high resolution never feasible before.

### BACKGROUND OF THE INVENTION

Spectroscopy plays an important role in variety of applications in many fields medicine, biology, chemistry, physics, industrial processes, environmental monitoring Example applications are fluorescence detection, materials characterization, reflectance measurement, Raman spectroscopy, and many others. Most spectroscopic instruments e.g. prism or grating spectrometers are based on spreading the input light along a predefined direction by using a dispersive element. In early spectroscopic instruments, the light is detected by a single element photosensitive detector which is moved along the spectrum spread direction. Each detector position corresponds to a certain wavelength and a complete spectrum is created after the completion of the detector scan. Another more popular approach to the spectrum scanning is based on a static detector and angular displacement of the dispersive element.

Prior art spectrum analysis devices are based on spreading a light along a line, the spectral information along this line is either mechanically scanned or projected onto a linear detector for data acquisition. The disadvantage of this prior art system is its limited resolution due to a limited number of pixels along the linear detector or the scanning device. Another disadvantage of the prior art is that spectral information spread along a line tends to interfere with each other because of multiple orders effect. Still another disadvantage of the prior art is that high resolution spectral information in the far infra red region is usually achieved by a scanning Fourier transform infra red (FTIR) spectrometer, which are very expensive and can not acquire all the spectral data simultaneously.

In order to overcome those difficulties and to improve the accuracy and resolution of said spectrometer the present invention utilizes a method where the said input light is spread into two dimensional array, where different locations of the two dimensional array have different spectral assignment The said two dimensional monochromatic array is further projected into a matching two dimensional detector where the power for each mean is detected.

Typical spectrometer instrument based on the above mentioned approach is described in FIG. 1(a). The light is focused on the entrance slit (101) and then collimated by a collimating element (102). The spectral resolution of the instrument is determined in particular by the divergence angle of the beam after the collimation, which depends on the slit width and collimating element quality. The collimated light is then incident on the dispersive element (103) like prism or diffraction grating that causes an extra tilt to the beam depending on its wavelength The diffracted or refracted beam is then refocused by the focusing element (104) on the exit slit (105) and detected by the detector (106). The exit slit width together with the entrance slit width affect the instrument resolution. For example, consider a first order diffraction grating based spectrometer with 600 grooves/mm grating, 260 mm collimating and refocusing elements and 200 μm entrance and exit slits The total instrument resolution can be derived from the following considerations. The diffraction grating deflects the beam incident at the angle α₀ by the angle α related to the grating parameters according to the following formula:

$$sin {α}_{0} + sin α = \frac{m λ}{d} , \qquad ( 1 )$$

where m—is the diffraction order, λ—the light wavelength and d—the grating period

The entrance slit width Δx creates the diffraction grating incident beam divergence according to the below:

$$Δ {α}_{0} = \frac{Λ x}{f} , \qquad ( 2 )$$

where f—is the collimating optics effective focal length.

The incidence angle uncertainty creates a wavelength resolution limit described by the below expression:

$$Δλ = \frac{d cos {α}_{0}}{mf} Δ x \qquad ( 3 )$$

In the example described above, the spectral resolution limitation by the entrance slit is about: Δλ=1.3 nm The exit slit width should correspond to the entrance slit width, since by increasing the exit slit the spectral resolution degrades while the resolution does not gain from the exit slit width decrease. Another resolution limitation specific to diffraction gratings is the diffraction grating resolution limit, described by the following equation:

$$\frac{λ}{Δλ} = \frac{m L}{d} , \qquad ( 4 )$$

where L—is the beam size on the diffraction grating. Typically the diffraction grating limit is far below the resolution limit caused by the entrance/exit slits and focusing elements imperfections For example, 10 mm beam on the grating results in Δλ<0.1 nm resolution limit

Both the dispersion element and the detector scanning methods are capable to provide high resolution spectra, but have several disadvantages. First, since each wavelength is detected independently, the whole spectrum acquisition requires a long period time. Due to this fact, scanning spectrometers are not suitable for measuring pulsed light spectra and transient effects that may last short time period. Second, the scanning mechanisms are costly have low reliability, and should be preferably avoided.

Another approach for spectrum detection is utilization of detector arrays, while the spectrum spread by the dispersive element is simultaneously detected by a plurality of detectors array channels This approach allows a construction of a non-scanning spectrometer, capable to measure continuous and pulsed light spectrum within short amount of time Typical layout of such instrument is shown in the FIG. 1(b).

The detectors array approach creates several resolution limitations. First, the instrument resolution is still limited by the entrance slit width and collimating optics quality Small lateral dimensions of each detector (pixel) functionally equivalent to the exit slit width, does not boost the instrument resolution Since the amount of detectors (pixels) in the array is limited, there is a trade-off between the covered spectral range and the resolution according to the following simple formula

$$Δλ = \frac{{λ}_{max} - {λ}_{min}}{N} , \qquad ( 5 )$$

where N—is the array size, i.e. the total number of detectors (pixels) For example, if the required spectral range is 300-1100 nm, and the array size is 1024 detectors, the spectral resolution is not better than Δλ-0.8 nm. To achieve better resolution with the same detectors array will require to decrease the covered spectral range, which is very complicated to achieve in a single instrument.

Yet another problem exists in non-scanning spectrometers covering a wide spectral range. Since the second order of the wavelength λ coincides with the first order of the wavelength 2λ, special techniques should be implemented in order to distinguish between the two wavelengths of different diffraction orders that are detected by a certain detector. One of the possible solutions is to use different filter on each detector that will allow only the appropriate wavelength to pass. Such filters are costly and generally have low extinction ratio

The present invention answers to all the above obstacles and provides a high spectral coverage while keeping a high resolution

### BRIEF DESCRIPTION OF THE INVENTION

There is thus provided in accordance with the preferred embodiment of the present invention a spectrometric device, the device comprising:
An optical assembly capable of spreading an input light into a two dimensional array of monochromatic beams.
A two dimensional detection system capable of sensing the optical power of the said beams
An electronic analyzing system to correctly process the power generated by the said two dimensional detection system into a high resolution spectrum data.

Furthermore, in accordance with another preferred embodiment of present invention, the device further comprises an optical assembly capable of spreading the input light into a two dimensional array of monochromatic beams further comprising of:
A dispersing element, dispersing said input light along a line.
A beam shaping module where said line is further divided into several shorter parts creating a two dimensional array of monochromatic beams to be projected onto a two dimensional sensor.

Furthermore, in accordance with another preferred embodiment of present invention, the said two dimensional sensor is optimized for the ultra violet part of spectrum

Furthermore, in accordance with another preferred embodiment of present invention, the said two dimensional sensor is optimized for the visible and near infrared part of spectrum.

Furthermore, in accordance with another preferred embodiment of present invention, the said two dimensional sensor is optimized for the medium and far infra red part of spectrum

Furthermore, in accordance with another preferred embodiment of present invention, the beam shaping module comprises of:
A lens capable of focusing the said spectral line into an optical fiber array, where each fiber contains a part of the spectrum
A collimating lens where the output end of the said optical fiber array nominally coincides with its focal plane
Said optical fiber array where its output end is differently shaped from its input end in order to create an array with the defined shape of monochromatic beams after the focusing element
A dispersing element to create a two dimensional array of dispersed monochromatic beams
A focusing element receiving the said bundles of monochromatic light and capable to focus the said bundles onto a two dimensional detector array.

There is also provided in accordance with a preferred embodiment of the present invention method for a spectroscopic device, the method comprising
providing an spectroscopic device comprising:
   An optical assembly capable of spreading an input light into a two dimensional array of monochromatic beams.
   A two dimensional detection system capable of sensing the optical power of the said beams
   An electronic analyzing system to correctly process the power generated by the said two dimensional detection system into a high resolution spectrum data.

Furthermore, in accordance with another preferred embodiment of present invention, the method further comprises an optical assembly capable of spreading the input light into a two dimensional array of monochromatic beams further comprising of
A dispersing element, dispersing said input light along a line
A beam shaping module where said line is further divided into several shorter parts creating a two dimensional array of monochromatic beams to be projected onto a two dimensional sensor.

Furthermore, in accordance with another preferred embodiment of present invention, the said two dimensional sensor is optimized for the ultra violet part of spectrum.

Furthermore in accordance with another preferred embodiment of present invention, the said two dimensional sensor is optimized for the visible and near infrared part of spectrum

Furthermore, in accordance with another preferred embodiment of present invention, the said two dimensional sensor is optimized for the medium and far infra red part of spectrum.

Furthermore, in accordance with another preferred embodiment of present invention, the beam shaping module comprises of:
A lens capable of focusing the said spectral line into an optical fiber array where each fiber contains a part of the spectrum.
A collimating lens where the output end of the said optical fiber array nominally coincides with its focal plane.
Said optical fiber array where its output end is differently shaped from its input end in order to create an array with the defined shape of monochromatic beams after the focusing element.
A dispersing element to create a two dimensional array of dispersed monochromatic beams

In a preferred embodiment the incident beam 201 is a collimated beam in order to create collimated dispersed beams 203.

In one alternative embodiment a dispersion element 202 is a glass prism.

Yet in other alternative embodiment a dispersion element 202 is a diffraction grating.

FIG. 3 shows a preferred implementation for the beam manipulation optical subsystem 204 The collimated beams 301 are focused by a focusing optical element 302 onto a linear optical fibers array 304. In one alternative embodiment a micro lenses array is positioned before the fibers array 304 in order to improve the light collection efficiency. The optical fibers at the output end are laterally displaced in such a way that the beams 306 collimated by a collimation optical element 305 are directed to angles required to create a two dimensional diffraction pattern by the element 206 conforming to the sensor 208 geometrical dimensions. In another preferred embodiment the fibers are displaced in longitudinal direction in order to compensate for the chromatic aberration induced by a collimating element 305.

In one alternative embodiment the optical elements 302,303 and 305 are lenses for visible and near infrared light spectroscopy.

In another alternative embodiment all the optical elements are mirrors in order to enable an infra red spectroscopy.

### EXAMPLE

FIG. 4(a) shows an example of optical layout for the disclosed system, where the focusing optical element 302 is a XXX focal length photographic lens 402 The diffracting element 403 is 1200 grooves/mm first order diffraction grating, a collimating element 305 is a XXX focal length photographic lens 404.
A focusing element receiving the said bundles of monochromatic light and capable to focus the said bundles onto a two dimensional detector array.

### BRIEF DESCRIPTION OF FIGURES

FIG. 1: A description of prior art spectrometric systems

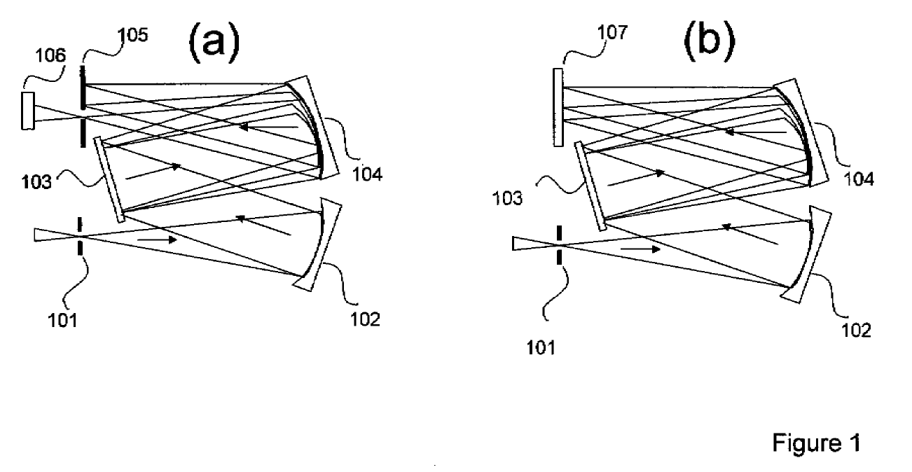

FIG. 2: General layout of the present invention

FIG. 3: Optical layout of a beam shaping module

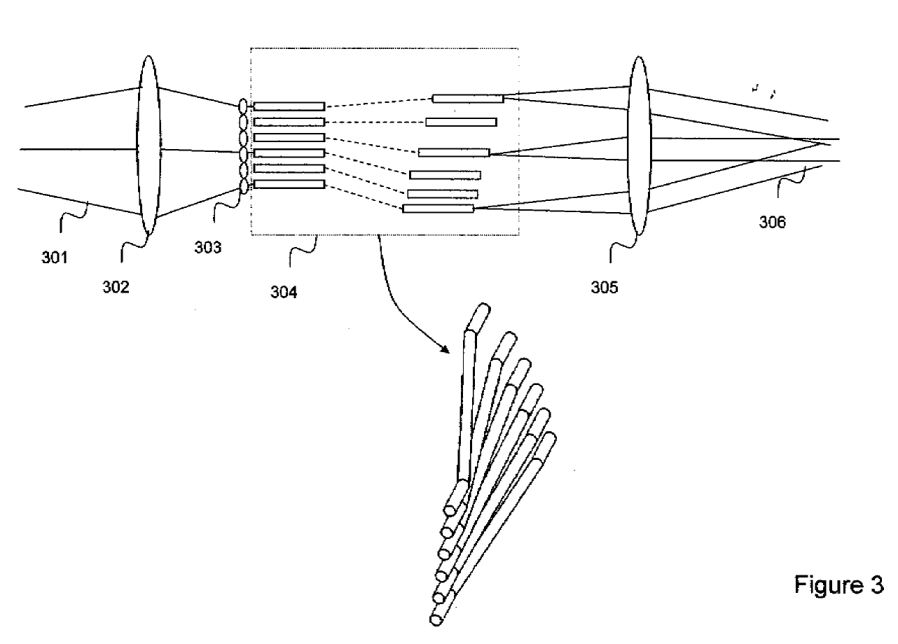

FIG. 4: Example implementation of the invention

FIG. 5: Example implementation results of the invention

### DETAILED DESCRIPTION OF THE INVENTION

In the present invention, we utilize a 2D detectors array following the specially designed optical system in order to construct a novel ultra-high resolution spectrometer with very wide spectral range without scanning elements.

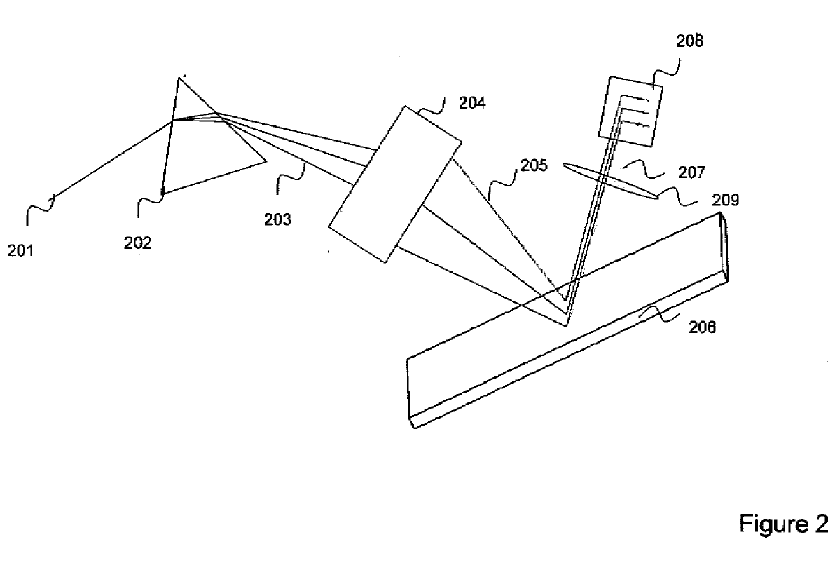

The basic operation principle is shown in the FIG. 2. The incident light 201 is dispersed by the first dispersion element 202. Array of beams 203, where each beam contains a particular part of the whole spectrum, are manipulated by the optical subsystem 204. The output beams 205 are incident onto a diffraction grating 206. The diffracted beams 207 are focused on a two dimensional sensor 208 by a focusing lens 209. The optical system 204 manipulates the input beams in such a way that after dispersion with element 206 they all the beams are diffracted at the same angle and substantially fit the sensor 208 area.

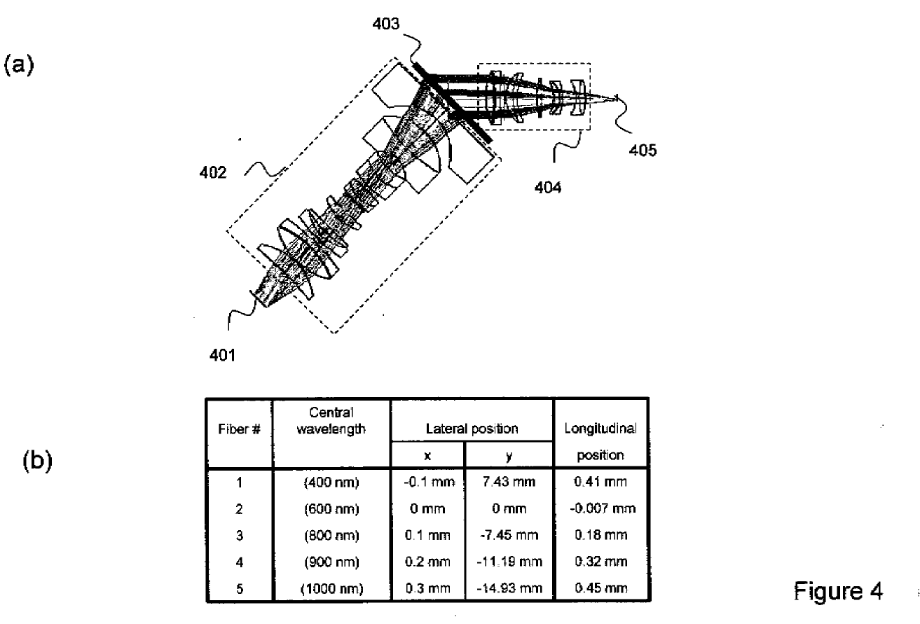

FIG. 4(b) shows the position of optical fibers before a collimating lens 402.

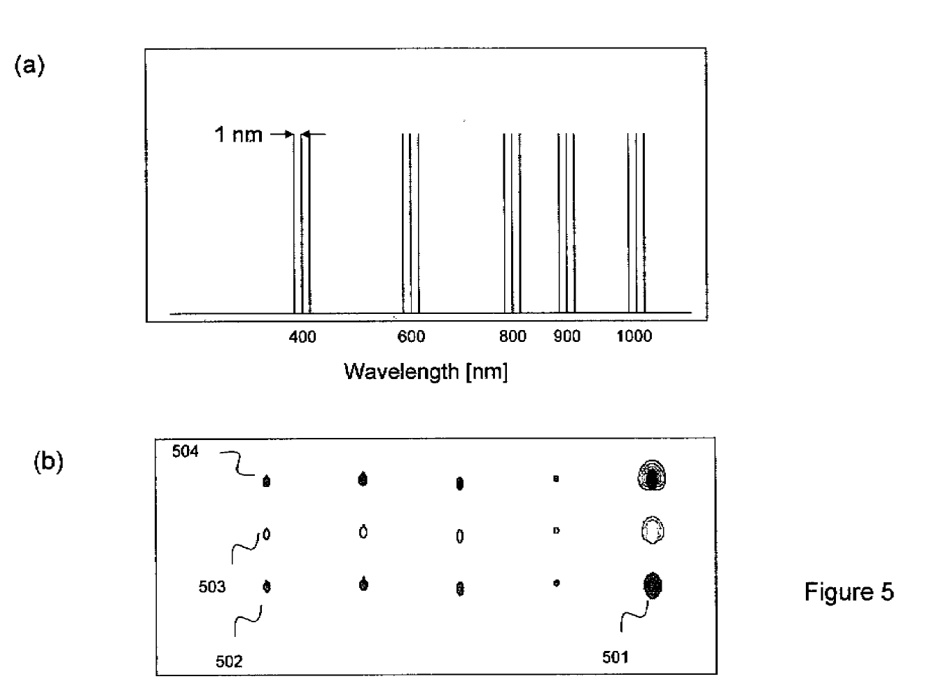

FIG. 5(a) shows an example of incident optical spectrum, consisting of 5 groups of sharp lines triplets separated by 1 nm at 400 nm, 600 nm, 800 nm; 900 nm and 1000 nm

FIG. 5(b) shows the image detected by a two dimensional array sensor 405 The vertical group of points 502,503 and 504 correspond to spectral lines triplet at 1000 nm The vertical group 501 corresponds to triplet at 400 nm.

1. A spectrum analyzing device comprising:
an optical assembly capable of spreading an input light into a two dimensional array of monochromatic beams;
a matching two dimensional detection system capable of sensing the optical power of the said beams, and
an electronic analyzing system for processing the power generated by said two dimensional detection system into spectral data.

2. A device according to claim 1, wherein said optical assembly further comprises:
a dispersing element, dispersing said input light along a line, and
a beam shaping module for further dividing said line into several shorter parts creating a two dimensional array of monochromatic beams, whereby each resultant beam is projected onto said two dimensional detection system.

3. A device as in claims 1 wherein said two dimensional detection system is optimized for the ultra violet part of spectrum.

4. A device according to claims 1 wherein said two dimensional sensor is optimized for the visible and near infrared part of spectrum.

5. A device according to claims 1 wherein said two dimensional sensor is optimized for the medium and far infrared part of spectrum.

6. A device according to claims 2 where the beam shaping module comprises:
a dispersing element to create two dimensional array of dispersed monochromatic beams,
an optical fiber array having an input end and an output end, the output end of which is shaped differently then its input end in order to create an array with the defined shape of monochromatic beams beyond the focusing element;
a lens capable of focusing said line of dispersed light into said optical fiber array, providing each fiber only a part of the spectrum, and
a collimating lens the focal plane of which nominally coincides with the output end of said optical fiber array.

7. A focusing element receiving bundles of monochromatic light from said output end of said optical fiber array, said focusing element being capable of focusing said bundles onto a two dimensional detector array.

8. A method for analyzing spectrum comprising:
spreading an input light beam into a two dimensional array of monochromatic beams;
detecting the optical power of said beams in two dimensions, and
electronically analyzing said power of said beams to correctly process the two dimensional output power of the detection system used to detect the optical power of said beams to provide spectral data.
